(19) United States
(12) Patent Application Publication
(10) Pub. No.: US 2019/0044230 A1
(43) Pub. Date: Feb. 7, 2019

(54) OMNIDIRECTIONAL ANTENNAS FOR UWB OPERATION, METHODS AND KITS THEREFOR

(71) Applicant: TAOGLAS GROUP HOLDINGS LIMITED, Enniscorthy (IE)

(72) Inventor: Andela ZARIC, Munich (DE)

(73) Assignee: TAOGLAS GROUP HOLDINGS LIMITED, Enniscorthy (IE)

(21) Appl. No.: 16/048,519

(22) Filed: Jul. 30, 2018

Related U.S. Application Data
(60) Provisional application No. 62/539,671, filed on Aug. 1, 2017.

(51) Int. Cl. H01Q 5/25; H01Q 1/12; H01Q 1/48

(52) U.S. Cl. CPC H01Q 5/25; H01Q 1/48; H01Q 1/12

(57) ABSTRACT

Small form factor omnidirectional UWB antennas are disclosed. The disclosed antennas comprise a dielectric substrate, a radiator element, a ground plane element, and cabling, typically of coaxial construction with industry-standard end connectors, to facilitate attachment to external devices and electronics. To further facilitate installation, the substrate may be adhesively backed. Radiator elements may be of various geometries and may contain one or more slots, notches, and/or apertures. Likewise, ground plane elements of may embody various geometries. For a given application, the radiator element and ground plane element may be selected and combined to achieve desired antenna performance.

### CROSS-REFERENCE

This application claims the benefit of U.S. Provisional Patent Application No. 62/539,671, filed Aug. 1, 2017, entitled PCB ANTENNAS FOR UWB OPERATION DIRECTLY FED BY A COAXIAL CABLE AND METHODS, which application is incorporated herein by reference.

### BACKGROUND

### Field

The present disclosure relates in general to an antenna, and, in particular, to omnidirectional ultra-wideband (UWB) antennas.

The FCC has defined UWB as an antenna transmission for which emitted signal bandwidth exceeds the lesser of 500 MHz or 20% of the arithmetic center frequency and has authorized the unlicensed use of UWB in the frequency range from 3.1 to 10.6 GHz. In EU applications, a sub-band from 6 GHz to 8.5 GHz, is authorized. Unlike current and historical narrow band communications systems such as Cellular, Wi-Fi and GNSS, UWB communications systems can address emerging market needs and offer a host of possibilities for new products and systems.

Existing localization technologies such as Assisted GPS for Indoors, Wi-Fi and Cellular fingerprinting are at best able to offer meter precision, while UWB enables centimeter level localization precision for indoor and outdoor localization as well as very high transmission speed. This technology potential comes from the ultra-wide frequency bandwidth which means that the radiated pulses can be of duration less than 1 millisecond.

Potential applications for UWB technologies include smart home and entertainment systems that can take advantage of high data rates for streaming high quality audio and video content in real-time, localization applications in healthcare and safety for seniors and infants, or even precise non-invasive and non-ionizing imaging for cancer detection. Other applications may include precise asset localization and identification for security, such as wireless keyless cars and premise entry systems. These and other applications dictate new approaches to communications systems design, opening possibilities for novel, advanced antenna design and implementation

What is needed are high performance, high efficiency (>75%) omnidirectional antennas designed for UWB frequencies. Additionally, what is needed are antennas having a small form factor and other features such as adhesive backing and highly flexible micro-coaxial cables to facilitate installation in limited-space applications.

### SUMMARY

Small form factor UWB antennas are disclosed. The disclosed antennas are omnidirectional and have an efficiency of greater than 75%. The antennas comprise a dielectric substrate, a metal radiator element, a metal ground plane element, and cabling, typically of coaxial construction with industry-standard end connectors, to facilitate attachment to external devices and electronics. To further facilitate installation, the substrate may be adhesively backed. The disclosed UWB antennas are capable of streaming audio and/or video content in real-time and processing a high volume of data real-time, e.g. greater than 100 Mbps of data. Additionally, the antennas do not require an external ground plane.

Radiator elements of various geometries and optionally containing one or more slots, notches, and/or apertures are disclosed. Likewise, ground plane elements of different varying geometry are disclosed. For a specific antenna according to the disclosure, the radiator element and ground plane element may be selected and combined to achieve desired antenna performance. Simulation, fabrication, and testing of two exemplar antennas confirm antenna performance.

An aspect of the disclosure is directed to ultra-wideband omnidirectional antennas. Ultra-wideband antennas comprise: a dielectric substrate having a substrate length, and a substrate width, a first surface, and a second surface; a radiator positioned on a portion of the first surface of the dielectric substrate having a shape selected from square, rectangular, diamond, semi-circular, circular, oval, trapezoidal, and hexagonal; a ground plane positioned on a portion of the first surface of the dielectric substrate adjacent the radiator; a gap on the dielectric substrate between the radiator and the ground plane; a radiator attachment pad positioned on the radiator; and a ground plane attachment positioned on the ground plane, wherein the antenna is not externally grounded. In some configurations, the ultra-wideband antenna operates within a range of frequencies from 3.1 GHz to 10 GHz. Additionally, the dielectric substrate of the ultra-wideband antenna can have a two-dimensional shape selected from square and rectangular. The dielectric substrate can also be planar in some configurations substantially planar. The radiator can have an aperture with a shape selected from u, square, rectangular, semi-circular, circular, trapezoidal, and triangular. Additionally, the ground plane can have a variety of shapes including a shape selected from square, rectangular, semi-circular, oval, circular, trapezoidal and triangular. Additionally, a cable can be provided having a first end and a second end wherein the first end is connected to the radiator attachment pad and the ground plane attachment pad. A connector can also be provided on the second end of the cable.

Another aspect of the disclosure is directed to an ultra-wideband omnidirectional antenna comprising: a dielectric substrate having a substrate length, and a substrate width, a first surface, and a second surface; a radiator positioned on a portion of the first surface of the dielectric substrate; a ground plane positioned on a portion of the first surface of the dielectric substrate adjacent the radiator having a shape selected from square, rectangular, semi-circular, oval, circular, trapezoidal and triangular; a gap on the dielectric substrate between the radiator and the ground plane; a radiator attachment pad positioned on the radiator; and a ground plane attach positioned on the ground plane, wherein the antenna is not externally grounded. The ultra-wideband antenna can operate within a range of frequencies from 3.1 GHz to 10 GHz. Additionally, the dielectric substrate of the ultra-wideband antenna can have a two-dimensional shape selected from square and rectangular. The dielectric substrate can also be planar in some configurations substantially planar. The radiator can have an aperture with a shape selected from u, square, rectangular, semi-circular, circular, trapezoidal, and triangular. Additionally, the ground plane can have a variety of shapes including a shape selected from square, rectangular, semi-circular, oval, circular, trapezoidal and triangular. Additionally, a cable can be provided having a first end and a second end wherein the first end is connected to the radiator attachment pad and the ground plane attachment pad. A connector can also be provided on the second end of the cable.

Yet another aspect of the disclosure is directed to a method of using an ultra-wideband omnidirectional antenna. Suitable methods comprise the steps of: providing an ultra-wideband omnidirectional antenna comprising a dielectric substrate having a substrate length, and a substrate width, a first surface, and a second surface, a radiator positioned on a portion of the first surface of the dielectric substrate having a shape selected from square, rectangular, diamond, semi-circular, circular, oval, trapezoidal, and hexagonal, a ground plane positioned on a portion of the first surface of the dielectric substrate adjacent the radiator, a gap on the dielectric substrate between the radiator and the ground plane, a radiator attachment pad positioned on the radiator, a ground plane attach positioned on the ground plane, wherein the antenna is not externally grounded; and operating the ultra-wideband antenna at radio-frequency communications from 3.1 GHz to 10 GHz. The methods can additionally comprise the steps of one or more of: streaming at least one of an audio content and a video content in real-time, processing greater than 100 Mbps of data, and processing with the antenna a signal an efficiency greater than 75%.

Still another aspect of the disclosure is directed to a method of using an ultra-wideband omnidirectional antenna comprising the steps of: providing an ultra-wideband omnidirectional antenna comprising a dielectric substrate having a substrate length, and a substrate width, a first surface, and a second surface, a radiator positioned on a portion of the first surface of the dielectric substrate, a ground plane positioned on a portion of the first surface of the dielectric substrate adjacent the radiator having a shape selected from square, rectangular, semi-circular, oval, circular, trapezoidal and triangular, a gap on the dielectric substrate between the radiator and the ground plane, a radiator attachment pad positioned on the radiator, and a ground plane attach positioned on the ground plane, wherein the antenna is not externally grounded; and operating the ultra-wideband antenna at radio-frequency communications from 3.1 GHz to 10 GHz. The methods can additionally comprise the steps of one or more of: streaming at least one of an audio content and a video content in real-time, processing greater than 100 Mbps of data, and processing with the antenna a signal an efficiency greater than 75%.

Another aspect of the disclosure is directed to an ultra-wideband omnidirectional antenna kit comprising: one or more ultra-wideband omnidirectional antenna comprising a dielectric substrate having a substrate length, and a substrate width, a first surface, and a second surface, a radiator positioned on a portion of the first surface of the dielectric substrate having a shape selected from square, rectangular, diamond, semi-circular, circular, oval, trapezoidal, and hexagonal, a ground plane positioned on a portion of the first surface of the dielectric substrate adjacent the radiator, a gap on the dielectric substrate between the radiator and the ground plane, a radiator attachment pad positioned on the radiator, a ground plane attach positioned on the ground plane, wherein the antenna is not externally grounded; and one or more ground planes, PCBs, connectors, and cables.

Still another aspect of the disclosure is directed to an ultra-wideband omnidirectional antenna kit comprising: one or more ultra-wideband omnidirectional antenna comprising a dielectric substrate having a substrate length, and a substrate width, a first surface, and a second surface, a radiator positioned on a portion of the first surface of the dielectric substrate, a ground plane positioned on a portion of the first surface of the dielectric substrate adjacent the radiator having a shape selected from square, rectangular, semi-circular, oval, circular, trapezoidal and triangular, a gap on the dielectric substrate between the radiator and the ground plane, a radiator attachment pad positioned on the radiator, and a ground plane attach positioned on the ground plane, wherein the antenna is not externally grounded; and one or more ground planes, PCBs, connectors, and cables.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example:
BONNET, et al., Ultra Wide Band Miniature Antenna, IEEE International Conference on Ultra-Wideband: 678-682, published in 2007;
LIU, et al., A Planar Chip Antenna for UWB Applications in Lower Band, 2007 IEEE Antennas and Propagation Society International Symposium: 5147-5150, published in 2007;
LEE, et al., Design of Compact Chip Antenna for UWB Applications, IEEE International Conference on Ultra-Wideband: 155-158, published in 2009;
MOLEX, Ultra-Wideband (UWB) PCB Antennas published Aug. 31, 2016;
PARK, et al., Compact UWB Chip Antenna Design, IEEE Proceedings of Asia-Pacific Microwave Conference 2010: 730-733, published in 2010;
VIKRAM, “A Planar Cavity Backed Slot Antenna Array for Ultra-Wideband Automotive Monopulse,” published May 31, 2010;
US 2006/0176221 A1 published Aug. 10, 2006, to Chen et al. for Low-Profile Embedded Ultra-Wideband Antenna Architecture for Wireless Devices;
US 2012/0206301 A1 published Aug. 16, 2012, to Flores-Cuadras et al. for Multi-Angle Ultra Wideband Antenna with Surface Mount Technology, Methods of Assembly and Kits Therefor;
US 2015/0133763 A1 published May 14, 2015, to Saroka et al. for Patches for the Attachment of Electromagnetic (EM) Probes;
U.S. Pat. No. 7,095,374 B2 issued Aug. 22, 2006, to Chen et al. for Low-Profile Embedded Ultra-Wideband Antenna Architectures for Wireless Devices;
U.S. Pat. No. 7,821,471 B2 issued Oct. 26, 2010, to Yoshioka et al. for Asymmetrical Flat Antenna, Methods of Manufacturing the Asymmetrical Flat Antenna, and Signal-Processing Unit Using the Same;
U.S. Pat. No. 8,717,240 B2 issued May 6, 2014, to Flores-Cuadras et al. for Multiple-angle Ultra Wideband Antenna with Surface Mount Technology;
U.S. Pat. No. 8,781,522 B2 issued Jul. 15, 2014, to Tran et al. for Adaptable Antenna System;
U.S. Pat. No. 9,024,831 B2 issued May 5, 2015, to Wang for Miniaturized Ultra-wideband Multifunction Antenna via Multi-mode Traveling Waves (TW);
U.S. Pat. No. 9,502,757 B2 issued Nov. 22, 2016, to Zuniga for Low Cost Ultra Wideband LTE Antenna;
U.S. Pat. No. 9,553,369 B2 issued Jan. 24, 2017, to Morin et al. for Ultra-Wideband Biconical Antenna with Excellent Gain and Impedance Matching;
U.S. Pat. No. 9,711,871 B2 issued Sep. 18, 2017, to Jones for High-band Radiators with Extended-Length Feed Stalks Suitable for Base Station Antennas; and
U.S. Pat. No. 9,755,302 B2 issued Sep. 5, 2017, to Flores-Cuadras et al. for Multipath Open Lop Antenna with Wideband Resonances for WAN Communications.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a planar illustration of a generic UWB antenna according to the disclosure;

FIGS. 2A-E are illustrations of configurations of a UWB antenna according to the disclosure;

FIGS. 3A-E are illustrations of exploded side views of the UWB antennas of FIGS. 2A-E showing the layers according to the disclosure;

FIGS. 4A-G are illustrations of radiator configurations for a UWB antenna according to the disclosure;

FIGS. 5A-F are illustrations of ground plane configurations for a UWB antenna according to the disclosure;

FIG. 6 is an illustration of an embodiment of a UWB antenna according to the disclosure;

FIG. 7 is an illustration of another embodiment of a UWB antenna according to the disclosure;

FIG. 8 is an illustration a copper-tape mock-up of an embodiment of a UWB antenna;

FIG. 9 illustrates another embodiment of a UWB antenna;

FIGS. 10A-D depict various antenna cable routing configurations for a UWB antenna according to the disclosure; and

FIG. 11 illustrates a pre-production sample of an embodiment of a UWB antenna.

### DETAILED DESCRIPTION

Disclosed are antennas designed for communications applications in the UWB spectrum from 3.1 GHz to 10.3 GHz which does not rely on an external ground. The antennas are omnidirectional and have an efficiency greater than 75%. The disclosed antennas comprise a dielectric substrate, a metal radiation element, a metal ground plane element, and cabling, typically of coaxial construction with industry-standard end connectors, to facilitate attachment to external devices and electronics. The substrate can be flexible, non-flexible, or rigid. To further facilitate installation of the antenna, the substrate may be adhesively backed.

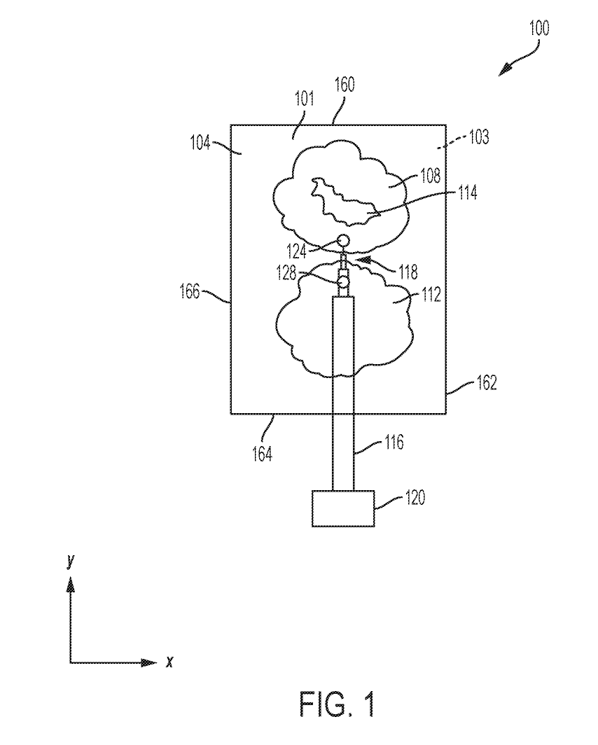

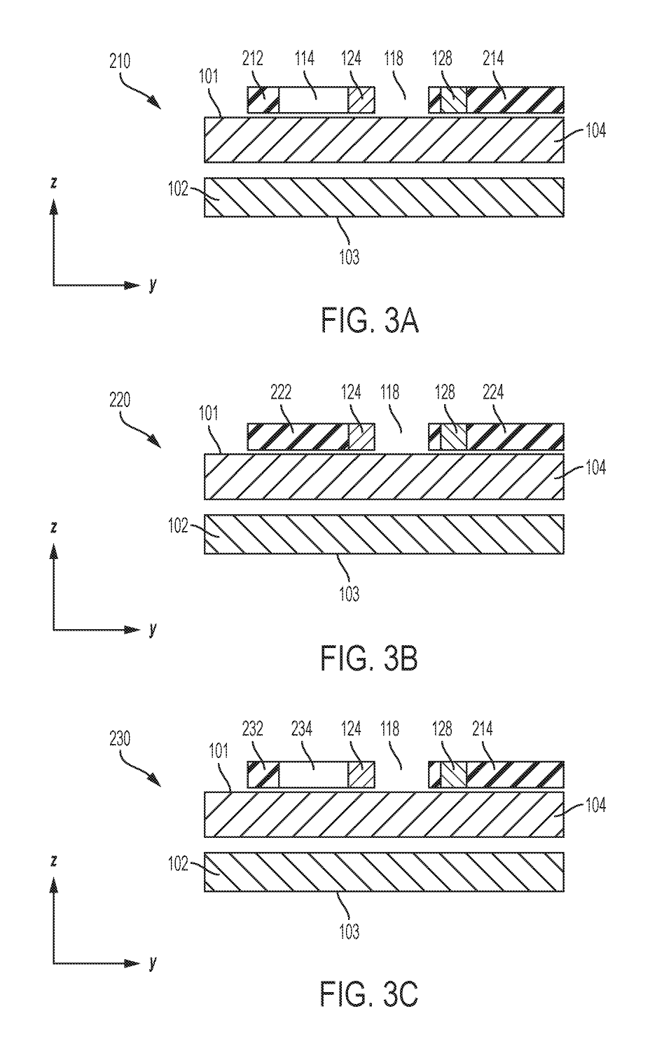

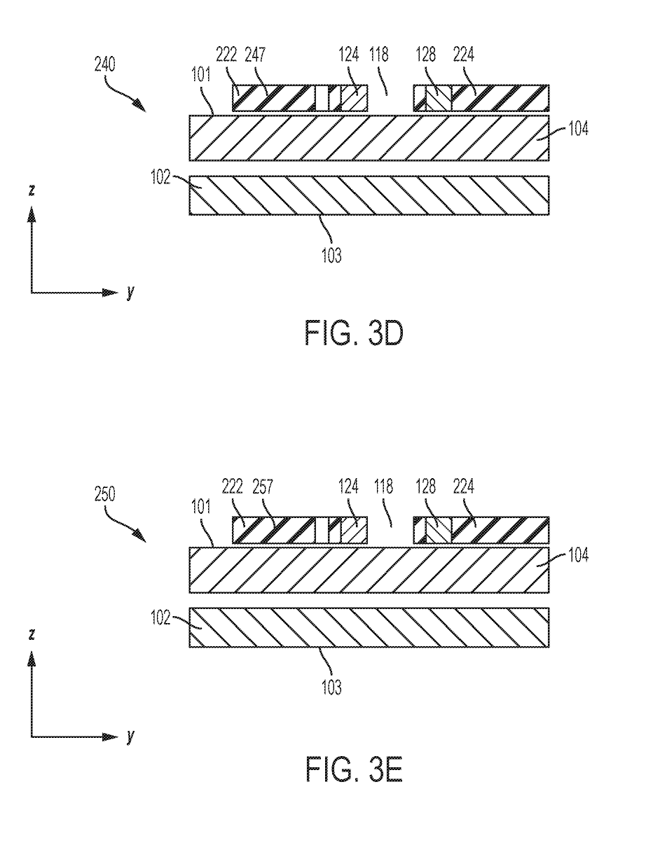

FIG. 1 depicts a generic antenna 100 from an upper surface 101 of a substrate 104 according to the disclosure in an x-y plane. In the embodiment illustrated, the antenna 100 is typically manufactured using printed circuit board (PCB) technology, although other production and/or fabrication techniques may be employed. When viewed in a plane, the antenna 100 has a top side 160, a right side 162, a bottom side 164, and a left side 166. The antenna 100 comprises: a substrate 104 having an upper surface 101 and a lower surface 103 with suitable dielectric properties upon which a radiator 108 (such as a generic radiator element) and a ground plane 112 (such as a generic ground plane element) are positioned adjacent one another on the substrate. A cable 116 with a connector 120 can be provided for connecting the antenna to external electronic equipment. The radiator 108 is separated from the ground plane 112 by a gap 118. On the opposite side of the substrate 104 (i.e., lower surface 103) is peel-and-stick adhesive to facilitate installation (examples of layers are illustrated in FIG. 3). In the generic embodiment depicted in FIG. 1, the radiator 108 contains an aperture 114, which may be employed for example, for specific band rejection. Other embodiments may, or may not, employ apertures, notches, slots, or similar features, on or in communication with a radiation element depending on the specific application(s) for which they are intended.

The radiator 108 and the ground plane 112 are metal or elements with suitable electric properties. The cable 116 is typically of coaxial construction. A highly flexible micro-coaxial cable may be employed to facilitate installation in limited-space applications. In the case where cable 116 is coaxial, an inner conductor of cable 116 is secured to the radiator 108 at a radiator attachment pad 124, via solder bonding or other suitable connection mechanism; and an outer conductor of the cable 116 is secured to the ground plane 112 of the antenna 100 at ground plane attachment pad 128, via solder bonding or other suitable mechanism. At the opposite end of the cable 116 is a connector 120. Suitable connectors include, for example, IPEX and sub-miniature version A (SMA) connectors. The connector 120 facilitates a secure connection of the antenna 100 to external electronics and/or other equipment.

The substrate 104 can have a dimension of from about 25 mm to about 45 mm, more preferably 34.4 mm, in a first dimension and from about 5 mm to about 15 mm, more preferably about 10 mm in a second dimension. The radiator 108 can have a dimension of from about 15 mm to about 35 mm, more preferably about 24 mm, in a first dimension, and a dimension of from about 15 mm to about 35 mm, more preferably about 24 mm, in a second dimension. The ground plane 112 can have a dimension of from about 5 mm to about 20 mm, more preferably about 10 mm, in a first dimension, and a dimension of from about 5 mm to about 20 mm, more preferably about 10 mm, in a second dimension. The gap 118 between the radiator 108 and the ground plane 112 can be from about 0.2 mm to about 0.6 mm, more preferably about 0.4 mm. An aperture of varying shapes can be provided in the radiator 108 as discussed in more detail below.

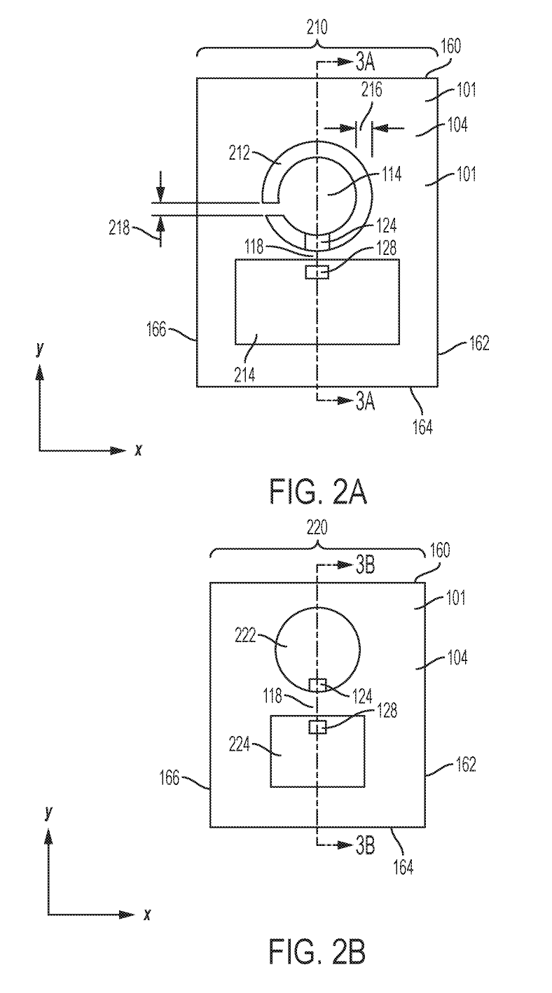

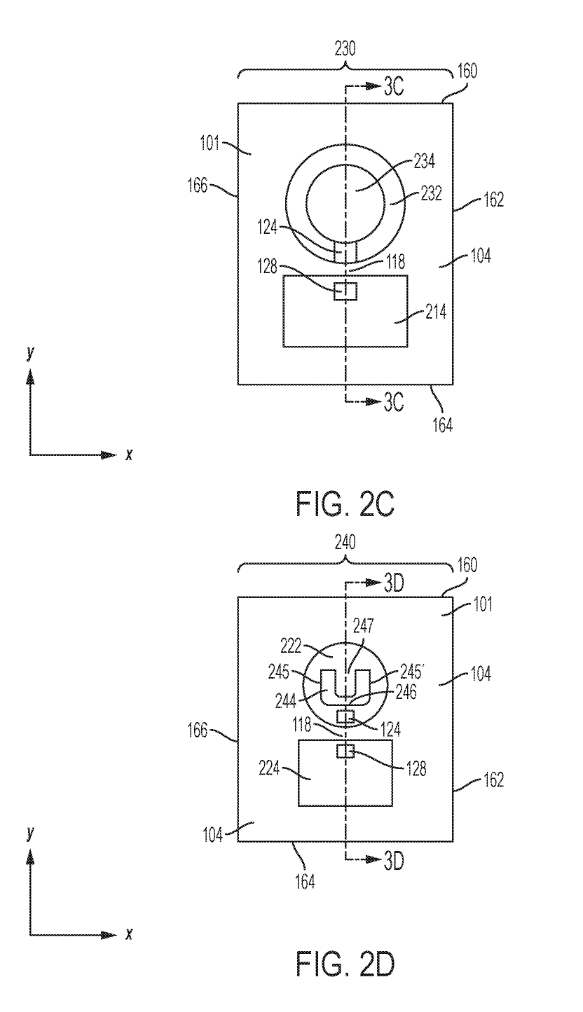

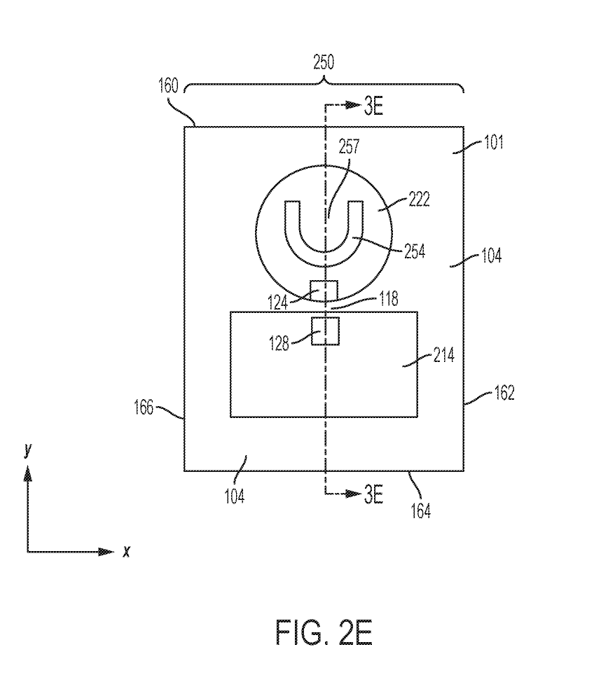

FIGS. 2A-E depict further embodiments of antennas 100 shown in FIG. 1 also in an x-y plane. In each exemplar embodiment illustrated, a substrate 104 (as described in FIG. 1) is employed as viewed from the first side 101. The antenna is illustrated with a top side 160, a right side 162, a bottom side 164, and a left side 166. Each of the disclosed antennas in FIGS. 2A-E are also depicted with a radiator attachment pad 124 positioned on the radiator at a location at or near an edge of the radiator near or nearest a ground plane attachment pad 128 which is positioned on the ground plane at a location at or near nearest the radiator attachment pad 124. For purposes of illustration, the radiator element is shown positioned near the top side 160, and the ground plane is shown positioned near the bottom side 164. Other layouts can be employed without departing from the scope of the disclosure.

Turning to FIG. 2A, a first antenna 210 configuration employs an open-ring radiator 212 and a rectangular ground plane 214 positioned on the substrate 104. The open-ring radiator 212 and the rectangular ground plane 214 are separated by a gap 118. The open-ring radiator 212 partially defines an aperture 114. Open-ring radiator 212 has a circular ring shape of thickness 216 and a an opening 218 along the length of the ring. The opening 218 of the open-ring radiator 212 can face, for example, to the right (towards the right side 162) or to the left (towards the left side 166, as illustrated). Other opening locations can be employed without departing from the scope of the disclosure. For example, the opening 218 can be positioned 45 degrees off of the current location, i.e., towards the corner between the top side 160 and the left side 166. Thus, the opening 218 can be positioned from 0 to 360 degrees off of the radiator attachment pad 124 without departing from the scope of the disclosure.

In practice, the thickness 216 of the ring and the gap dimension 218 can vary depending on the embodiment. Additionally, the thickness can vary long its length in a single embodiment. The radiator attachment pad 124 is positioned on the open-ring radiator 212 at or near the gap 118 between the open-ring radiator 212 and the ground plane attachment pad 128 which is positioned at or near the gap 118 on the rectangular ground plane 214.

In another embodiment illustrated in FIG. 2B, a second antenna 220 configuration comprises a circular radiator 222 and a square ground plane 224 positioned adjacent the circular radiator 222 on the substrate 104 and separated by a gap 118. The circular radiator 222 has a radiator attachment pad 124 positioned on the circular radiator 222 at a location near the ground plane 224. The ground plane 224 has a ground plane attachment pad 128 positioned at a location near the circular radiator 222.

As depicted in FIG. 2C, a third antenna 230 configuration employs a ring radiator 232 with a circular aperture 234 having a radius and a rectangular ground plane 214 positioned adjacent the ring radiator 232 on the substrate 104 and separated by a gap 118. The circular aperture 234 illustrated as centered within the ring radiator 232. In some configurations, the circular aperture can be positioned off-center. As will be appreciated by those skilled in the art, both the radius and the placement of the circular aperture 234 within the ring radiator 232 may vary without departing from the scope of the disclosure. The ring radiator 232 has a radiator attachment pad 124 positioned on the ring radiator 232 at a location adjacent the gap 118. The thickness of the radiator attachment pad 124 can be as thick as the ring radiator 232 in one dimension (as illustrated), or less than the thickness of the ring radiator 232 without departing from the scope of the disclosure. The rectangular ground plane 214 has a ground plane attachment pad 128 positioned at a location adjacent the gap 118.

Turning to FIG. 2D, a fourth antenna 240 configuration employs a circular radiator 222 with a squared-u aperture 244 having squared edges and a square ground plane 224. The squared-u aperture 244 features two substantially upright apertures 245, 245′ (uprights) connected at their base by a horizontal aperture section 246, all of narrow rectangular profile so that the resulting aperture looks like a squared-off letter “U” where the opening of the “U” has a width 247 faces away from the from the ground plane 224. The circular radiator 222 has a radiator attachment pad 124 positioned on the circular radiator 222 adjacent the gap 118. The square ground plane 224 has a ground plane attachment pad 128 positioned at a location adjacent the gap 118.

FIG. 2E illustrates a fifth antenna 250 configuration that employs a circular radiator 222 with a rounded u-shaped aperture 254 and a rectangular ground plane 214. The opening of the “U” has a width 257 faces away from the from the rectangular ground plane 214. The circular radiator 222 has a radiator attachment pad 124 positioned adjacent the ground plane attachment pad 128 on the substrate 104 and separated by a gap 118 from the rectangular ground plane 214. A UWB antenna is designed to operate over a wide frequency range and, for some designs, over multiple octaves. Consequently, the actual dimensions of any embodiment can vary.

As illustrated, the fourth antenna 240 configuration and the fifth antenna 250 configuration, the squared-u aperture 244 and the rounded u-shaped aperture 254, respectively, can be centered left-to-right within the circular radiator 222 and aligned such that their upright arms are parallel to the long dimension of the substrate 104. In similar embodiments, the placement and rotation of the squared-u aperture 244 and the rounded u-shaped aperture 254 within the circular radiator 222 may vary. As will be appreciated by those skilled in the art, the various embodiments illustrated in FIGS. 2A-E may be modified in numerous aspects without departing from the scope and spirit of the disclosure.

FIGS. 3A-E are cross-sectional views of exploded layers of the antennas of FIGS. 2A-E in a perpendicular plane, such as the y-z plane illustrated, along the lines 3A-3A, 3B-3B, 3C-3C, 3D-3D, and 3E-3E show in in FIGS. 2A-E. An adhesive layer 102 is positionable against a substrate 104. The ground plane (for example, the rectangular ground plane 214 or square ground plane 224 shown in FIGS. 2A-E) is positioned towards a first end of the antenna. The ground plane has a ground plane attachment pad 128. The ground plane is separated from the radiator by a gap 118. The radiator in cross-section can have one or more components as will be appreciated by looking at FIGS. 2A-E. The radiator also has a radiator attachment pad 124.

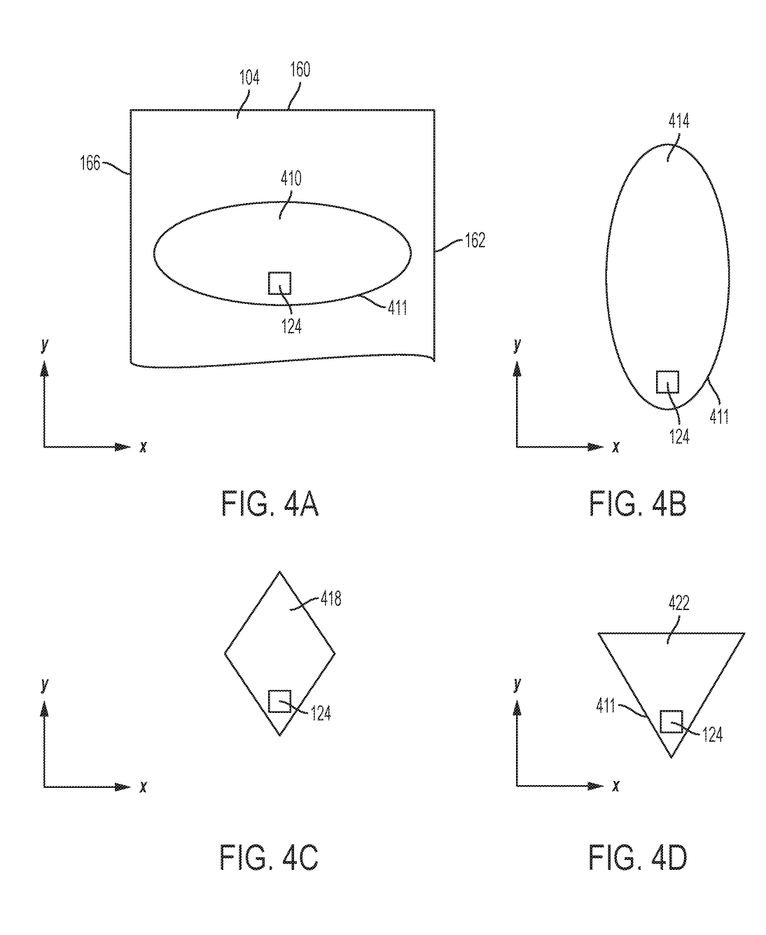

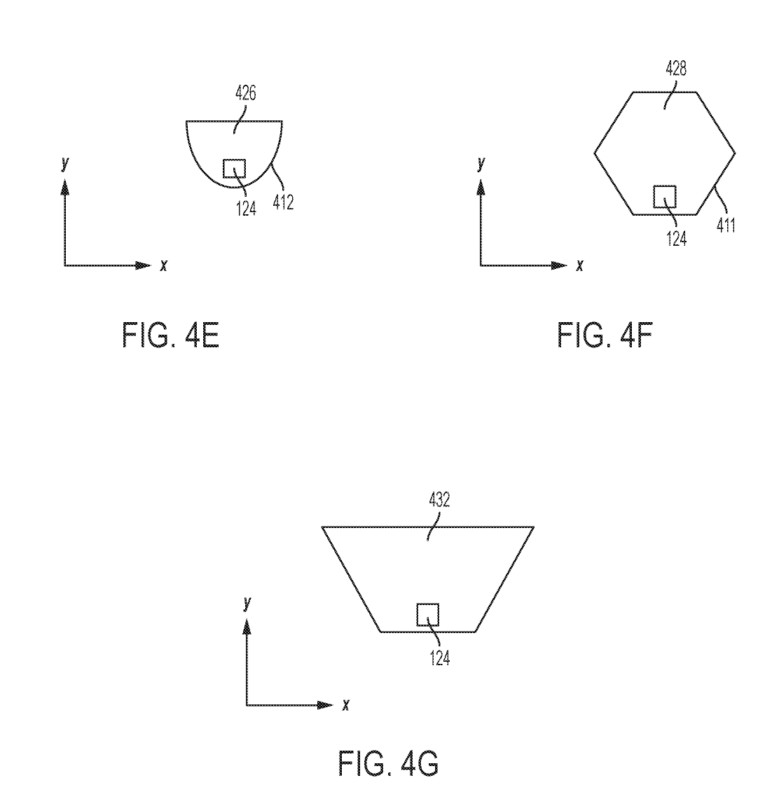

As will be appreciated by those skilled in the art, numerous radiator geometries are possible and may be employed depending upon the desired performance characteristics of the antenna 100 (FIG. 1). FIGS. 4A-G illustrate a plurality of radiator configurations. FIG. 4A illustrates a radiator configuration on a portion of the substrate 104 having a top side 160, a right side 162, and a left side 166; FIGS. 4B-G illustrate radiator shapes without the substrate.

Turning to FIG. 4A, a horizontal elliptical radiator 410 positioned on a portion of a substrate 104 with a radiator attachment pad 124 is illustrated in an exemplar x-y plane. The horizontal elliptical radiator 410 has a long axis in the x axis and a short axis in the y axis. Radiator apertures of a variety of configurations can be provided on the horizontal elliptical radiator 410, without departing from the scope of the disclosure. The radiator attachment pad 124 is illustrated positioned midway along the long axis of the horizontal elliptical radiator 410 near an outer edge 411.

FIG. 4B illustrates a vertical elliptical radiator 414 having a long axis in the y axis and a short axis in the x axis. Radiator apertures of a variety of configurations can be provided on the vertical elliptical radiator 414, without departing from the scope of the disclosure. The radiator attachment pad 124 is illustrated positioned midway along the short axis of the vertical elliptical radiator 414 near an outer edge 411.

FIG. 4C illustrates a diamond-shaped radiator 418 with a radiator attachment pad 124 positioned near a corner. Radiator apertures of a variety of configurations can be provided on the diamond-shaped radiator 418, without departing from the scope of the disclosure. The radiator attachment pad 124 is illustrated positioned in a corner of the diamond-shaped radiator 418 at a location that would be positioned near the ground plane.

FIG. 4D illustrates a triangular radiator 422 positioned in a corner of the triangle. Radiator apertures of a variety of configurations can be provided on the triangular radiator 422, without departing from the scope of the disclosure. The radiator attachment pad 124 is positioned in a corner of the triangular radiator 422 near an outer edge 411.

FIG. 4E illustrates a semi-circular radiator 426 having a curved edge and a flat, or substantially flat, edge with a radiator attachment pad 124 positioned along a curved edge 412 of the semi-circular radiator 426. Radiator apertures of a variety of configurations can be provided on the semi-circular radiator 426, without departing from the scope of the disclosure.

FIG. 4F illustrates a hexagonal radiator 428 with a radiator attachment pad 124 along an outer edge 411 of the hexagonal radiator 428. Radiator apertures of a variety of configurations can be provided on the hexagonal radiator 428, without departing from the scope of the disclosure.

FIG. 4G illustrates a trapezoid radiator 432 with a radiator attachment pad 124 near an outer edge 411. Radiator apertures of a variety of configurations can be provided on the trapezoid radiator 432, without departing from the scope of the disclosure.

Further permutations are possible, considering the numerous geometries and orientations of apertures, notches, and slots that might be employed in conjunction with each radiator configuration. Additionally, the orientation of the radiators depicted in an x-y plane in FIGS. 4A-G, can be rotated around an axis within a plane, e.g., the inverted trapezoid shown in FIG. 4G can be rotated so that the radiator is a trapezoid without departing from the scope of the disclosure.

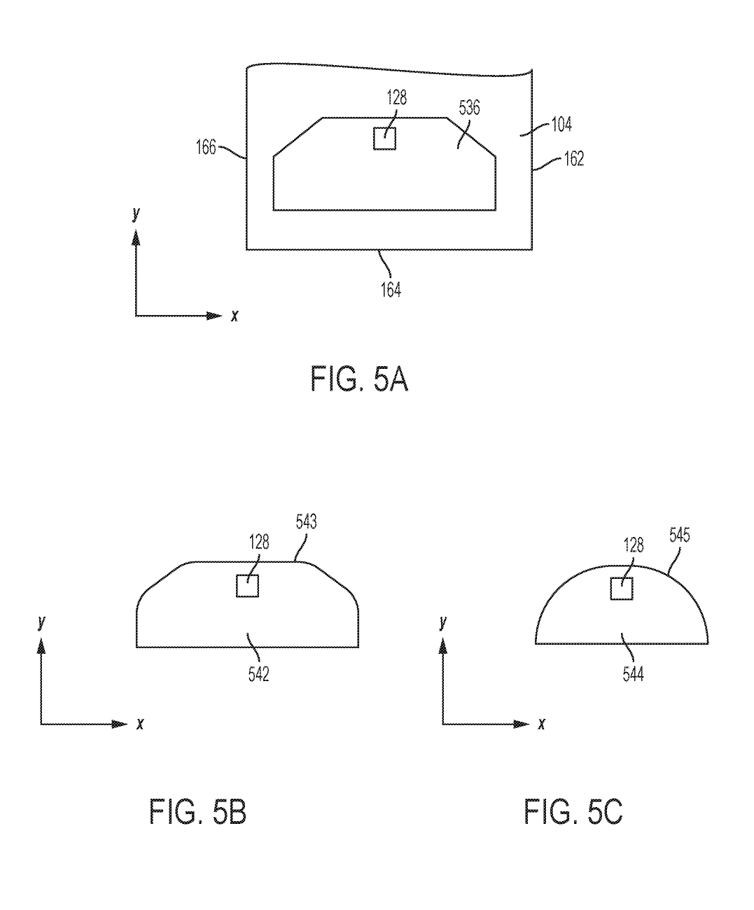

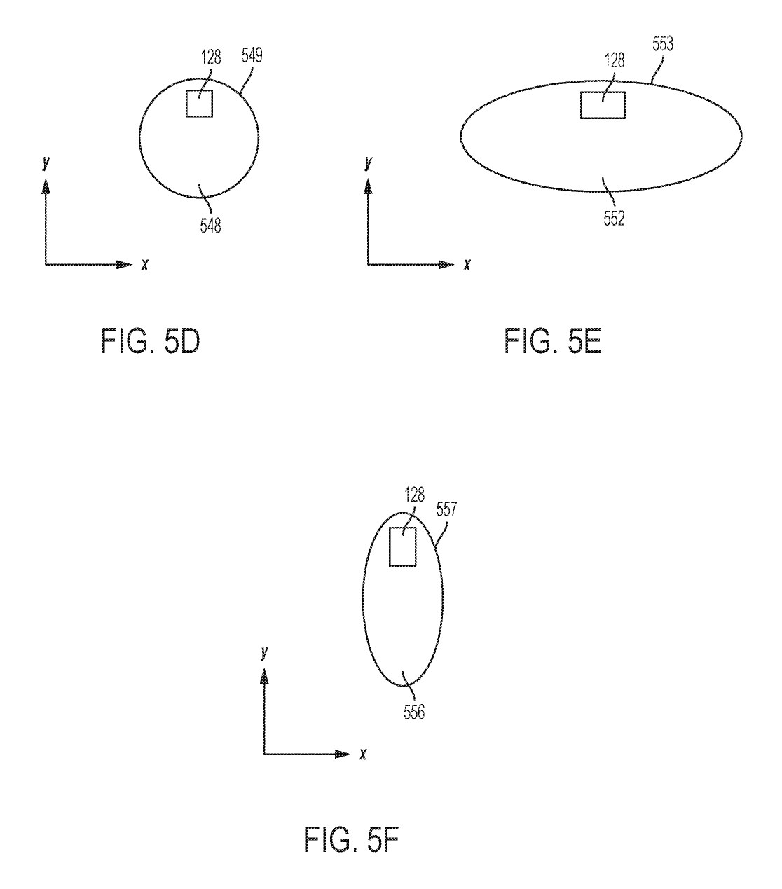

Numerous ground plane geometries are likewise possible. Potential ground plane geometries are illustrated in FIGS. 5A-F. FIG. 5A illustrates the ground plane in an exemplar x-y plane on a substrate 104 with a right side 162, a bottom side 164, and a left side 166; FIGS. 5B-5F illustrate ground plane configures without the substrate.

A truncated rectangular ground plane 536 configuration, shown in FIG. 5A, is a rectangle with two-truncated-corners ground plane with a ground plane attachment pad 128 positioned on a portion of the substrate 104.

FIG. 5B illustrates a rectangle-with-two-radiused-corners ground plane 542 with a ground plane attachment pad 128 positioned on an edge 543 positionable near the radiator that the ground plane is paired with.

FIG. 5C illustrates a semi-circular ground plane 544. The a semi-circular ground plane 544 is positioned so that the ground plane attachment pad 128 is positioned adjacent a circular edge 545 at a location that would be adjacent the radiator.

Circular ground plane 548 is shown in FIG. 5D with a ground plane attachment pad 128. The ground plane attachment pad 128 is positionable near an edge 549 that would be adjacent the radiator.

A horizontal elliptical ground plane 552 has a ground plane attachment pad 128 positioned along an upper length of the upper surface as shown in FIG. 5E. The attachment pad 128 is positionable at a location near edge 553 that would be adjacent the radiator.

A vertical elliptical ground plane 556 with a ground plane attachment pad 128 is shown in FIG. 5F. The ground plane attachment pad 128 is positionable at a location near edge 557 that would be adjacent the radiator.

Taken together, radiator geometries, aperture configurations and orientations, and ground plane geometries produce a plurality of possible antenna configurations encompassed by the disclosure.

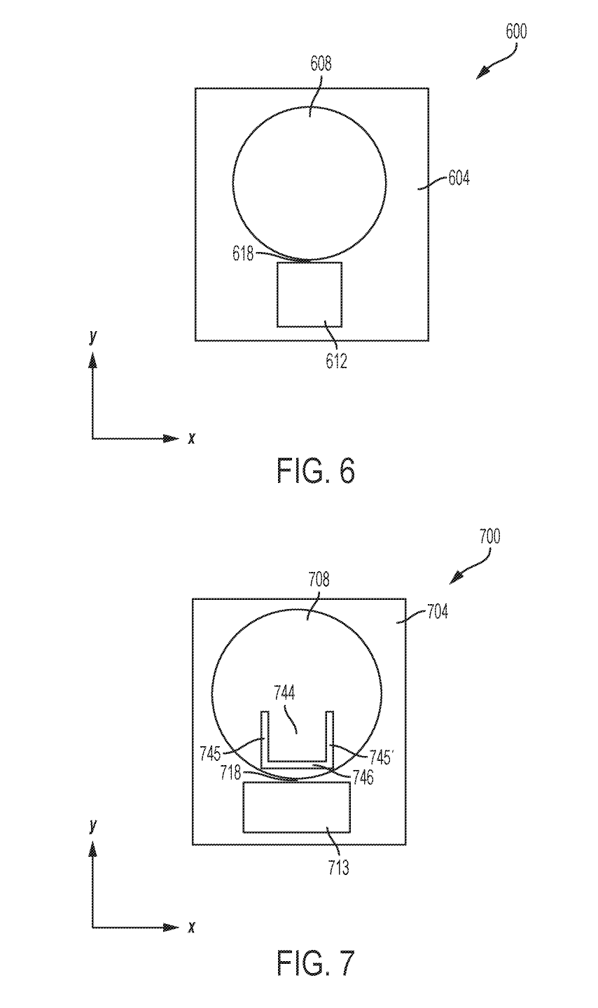

FIG. 6 illustrates a square antenna 600. The square antenna 600 has a square substrate 604. The square substrate 604 can have a dimension of from about 25 mm to about 45 mm in each of an x and y direction, more preferably about 34.4 mm. A circular radiator 608 is provided which can be from about 15 mm to about 35 mm in diameter, more preferably about 24 mm in diameter. A square ground plane 612 is provided which can be from about 5 mm to about 15 mm in both an x and a y direction, more preferably about 10 mm. A gap 618 between the square ground plane 612 and the circular radiator 608 can separate the two components at its closest point from about 0.2 mm to about 0.6 mm, more preferably about 0.4 mm.

FIG. 7 illustrates another embodiment of a square antenna 700. The square antenna 700 has a square substrate 704. The square substrate 704 can have a dimension of from about 25 mm to about 45 mm in each of an x and y direction, more preferably about 34.4 mm. A circular radiator 708 is provided which can be from about 15 mm to about 35 mm in diameter, more preferably about 24 mm in diameter. A rectangular ground plane 713 is provided which can be from about 5 mm to about 15 mm in a first dimension, more preferably about 10 mm, and from about 4 out 11 mm in a second dimension, more preferably about 7 mm. A gap 718 between the rectangular ground plane 713 and the circular radiator 708 can separate the two components at its closest point from about 0.2 mm to about 0.6 mm, more preferably about 0.4 mm. A u-shaped aperture 744 is provided on the circular radiator 708. The u-shaped aperture 744, has a two parallel, or substantially parallel arms 745, 745′ having a length of from about 6 mm to about 10 mm, more preferably about 8 mm. The two parallel arms 745, 745′ are continuous with a perpendicular connecting arm 746 connecting one end of each of the perpendicular arms. The length of the perpendicular connecting arm 746 has a length of from about 6 mm to about 10 mm, more preferably about 8 mm. As illustrated, the u-shaped aperture 744 has a square shape with one open end.

The y-axis centerlines of the antennas shown in FIG. 6 and FIG. 7 are coincident, resulting in a left-right symmetry of the antenna.

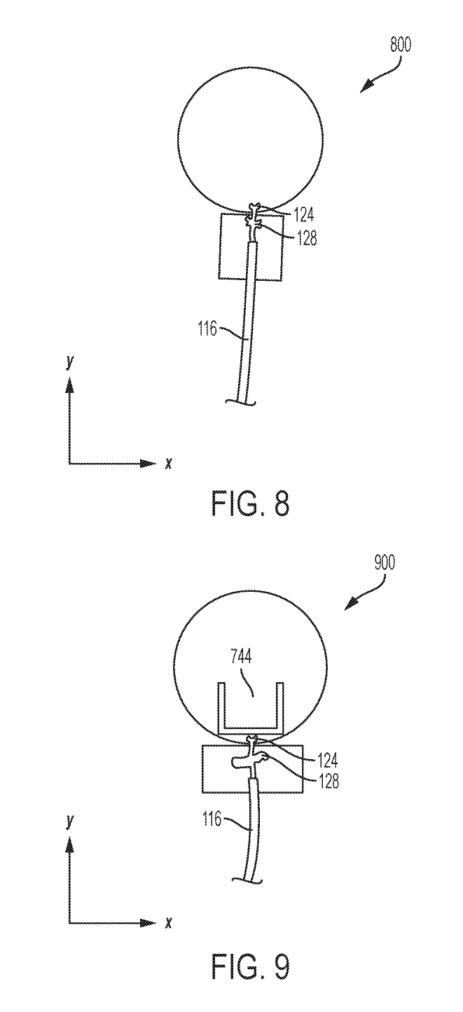

FIG. 8 is a UWB antenna 800 which can be fabricated from, for example, copper tape. Dimensions of antenna 800 match those of antenna 600 shown in FIG. 6. Cable 116 is attached via a radiator attachment pad 124, or first connection point, and ground plane attachment pad 128 or second connection point.

FIG. 9 is another antenna 900. Dimensions of antenna 900 match those of antenna 700 shown in FIG. 7. Cable 116 is attached via a radiator attachment pad 124, or first connection point, and ground plane attachment pad 128, or second connection point.

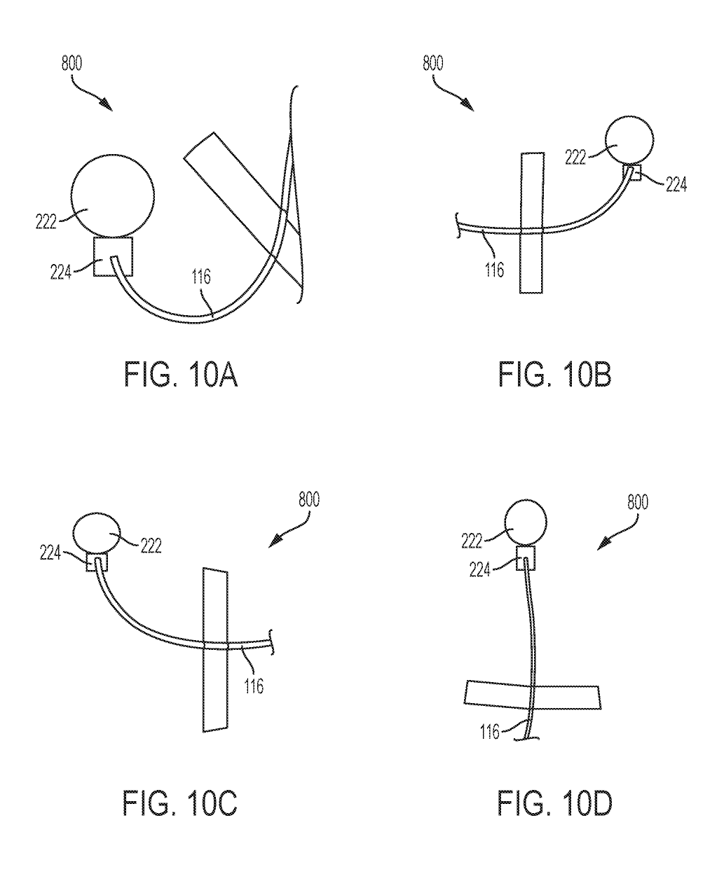

FIGS. 10A-D are a series of figures depicting various antenna cable routing configurations using the antenna 800 shown in FIG. 8 as an example without the attachment pads. By measuring and comparing the return loss for each of the configurations, the effect of cable routing on antenna performance can be determined. In a configuration, shown in FIG. 10A, the cable 116 has a u-turn configuration. The cable 116 extends from the square ground plane 224, and then curves on one side or another so that a portion of the cable is adjacent the side of the antenna 800. In another configuration, shown in FIG. 10B, the cable 116 extends from the square ground plane 224 and turns in a second direction, e.g. a left-turn if the cable extends from the square ground plane 224 and extends towards the bottom of the page. Turning to FIG. 10C, the cable 116 extends from the square ground plane 224 and turns in a first direction, e.g., a right-turn if the cable extends from the square ground plane 224 is positioned towards the bottom of the page. FIG. 10D, displays a configuration in which the cable 116 proceeds straightaway from the square ground plane 224 of the antenna 800. A variety of cable routing, as illustrated, is possible because the cable routing has a negligible effect on the antenna return loss.

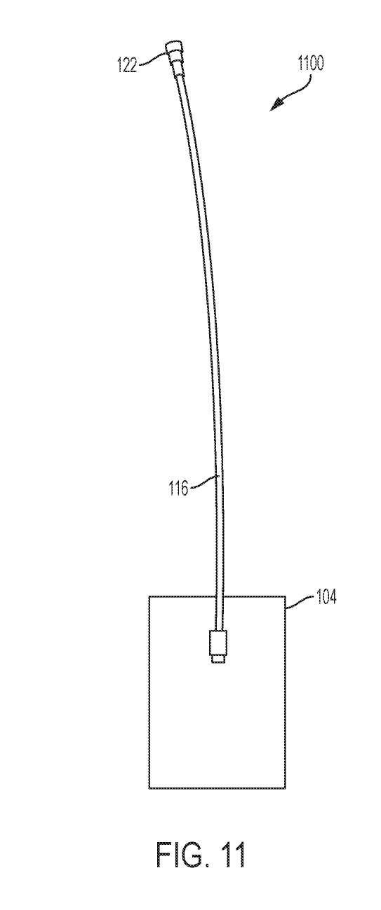

FIG. 11 illustrates an omnidirectional UWB antenna according to the disclosure. The antenna 1100 is fabricated using standard PCB production techniques on a substrate. The radiator and ground plan is positioned in a rectangular housing. Radiator and ground plane dimensions of antenna 1100 match those of first simulation antenna 800 (FIG. 8). A cable 116 and a connector 122 are also shown. The UWB antennas according to the disclosure have a good impedance match across a frequency band of interest, a good radiation efficiency, and omni-directional (or substantially omni-directional) radiation patterns. Changes in radiation patterns are minimal as a function of frequency.

A method of operating an omnidirectional UWB antenna across a spectrum from 3.1 GHz to 10.3 GHz which does not rely on an external ground is disclosed. The antennas can process a large amount of data real-time, e.g. 100 Mbps of data. Methods include providing an ultra-wideband omnidirectional antenna comprising a dielectric substrate having a substrate length, and a substrate width, a first surface, and a second surface, a radiator positioned on a portion of the first surface of the dielectric substrate having a shape selected from square, rectangular, diamond, semi-circular, circular, oval, trapezoidal, and hexagonal, a ground plane positioned on a portion of the first surface of the dielectric substrate adjacent the radiator, a gap on the dielectric substrate between the radiator and the ground plane, a radiator attachment pad positioned on the radiator, a ground plane attachment positioned on the ground plane, and a cable connected to the radiator attachment pad and the ground plane attachment pad; and operating the ultra-wideband antenna at radio-frequency communications from 3.1 GHz to 10 GHz.

The disclosed antennas can be provided in a kit which includes, for example, a cable (such as a coaxial cable). The cable can be used by a customer to directly connect to an external UWB antenna without needing to install the antenna on the host PCB.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An ultra-wideband omnidirectional antenna comprising:
a dielectric substrate having a substrate length, and a substrate width, a first surface, and a second surface;
a radiator positioned on a portion of the first surface of the dielectric substrate having a shape selected from square, rectangular, diamond, semi-circular, circular, oval, trapezoidal, and hexagonal;
a ground plane positioned on a portion of the first surface of the dielectric substrate adjacent the radiator;
a gap on the dielectric substrate between the radiator and the ground plane;
a radiator attachment pad positioned on the radiator; and
a ground plane attachment positioned on the ground plane,
wherein the antenna is not externally grounded.

2. The ultra-wideband omnidirectional antenna of claim 1 wherein the ultra-wideband antenna operates within a range of frequencies from 3.1 GHz to 10 GHz.

3. The ultra-wideband omnidirectional antenna of claim 1 wherein the dielectric substrate has a two-dimensional shape selected from square and rectangular.

4. The ultra-wideband omnidirectional antenna of claim 1 wherein the dielectric substrate is at least one of planar and substantially planar.

5. The ultra-wideband omnidirectional antenna of claim 1 wherein the radiator has an aperture with a shape selected from u, square, rectangular, semi-circular, circular, trapezoidal, and triangular.

6. The ultra-wideband omnidirectional antenna of claim 1 wherein the ground plane has a shape selected from square, rectangular, semi-circular, oval, circular, trapezoidal and triangular.

7. The ultra-wideband omnidirectional antenna of claim 1 further comprising a cable having a first end and a second end wherein the first end is connected to the radiator attachment pad and the ground plane attachment pad.

8. The ultra-wideband omnidirectional antenna of claim 7 further comprising a connector connected to a second end of the cable.

9. An ultra-wideband omnidirectional antenna comprising:
a dielectric substrate having a substrate length, and a substrate width, a first surface, and a second surface;
a radiator positioned on a portion of the first surface of the dielectric substrate;
a ground plane positioned on a portion of the first surface of the dielectric substrate adjacent the radiator having a shape selected from square, rectangular, semi-circular, oval, circular, trapezoidal and triangular;
a gap on the dielectric substrate between the radiator and the ground plane;
a radiator attachment pad positioned on the radiator; and
a ground plane attach positioned on the ground plane,
wherein the antenna is not externally grounded.

10. The ultra-wideband omnidirectional antenna of claim 9 wherein the ultra-wideband antenna operates within a range of frequencies from 3.1 GHz to 10 GHz.

11. The ultra-wideband omnidirectional antenna of claim 9 wherein the dielectric substrate has a two-dimensional shape selected from square and rectangular.

12. The ultra-wideband omnidirectional antenna of claim 9 wherein the dielectric substrate is at least one of planar and substantially planar.

13. The ultra-wideband omnidirectional antenna of claim 9 wherein the radiator has an aperture with a shape selected from u, square, rectangular, semi-circular, circular, trapezoidal, and triangular.

14. The ultra-wideband omnidirectional antenna of claim 9 wherein the radiator has a shape selected from square, rectangular, diamond, semi-circular, circular, oval, trapezoidal, and hexagonal.

15. The ultra-wideband omnidirectional antenna of claim 9 further comprising a cable having a first end and a second end wherein the first end is connected to the radiator attachment pad and the ground plane attachment pad.

16. The ultra-wideband omnidirectional antenna of claim 15 further comprising a connector connected to a second end of the cable.

17. An ultra-wideband omnidirectional antenna method comprising the steps of:
providing an ultra-wideband omnidirectional antenna comprising a dielectric substrate having a substrate length, and a substrate width, a first surface, and a second surface, a radiator positioned on a portion of the first surface of the dielectric substrate having a shape selected from square, rectangular, diamond, semi-circular, circular, oval, trapezoidal, and hexagonal, a ground plane positioned on a portion of the first surface of the dielectric substrate adjacent the radiator, a gap on the dielectric substrate between the radiator and the ground plane, a radiator attachment pad positioned on the radiator, a ground plane attach positioned on the ground plane, wherein the antenna is not externally grounded; and
operating the ultra-wideband antenna at radio-frequency communications from 3.1 GHz to 10 GHz.

18. The ultra-wideband omnidirectional antenna method of claim 17 further comprising the step of:
streaming at least one of an audio content and a video content in real-time.

19. The ultra-wideband omnidirectional antenna method of claim 17 further comprising the step of:
processing greater than 100 Mbps of data.

20. An ultra-wideband omnidirectional antenna method comprising the steps of:
providing an ultra-wideband omnidirectional antenna comprising a dielectric substrate having a substrate length, and a substrate width, a first surface, and a second surface, a radiator positioned on a portion of the first surface of the dielectric substrate, a ground plane positioned on a portion of the first surface of the dielectric substrate adjacent the radiator having a shape selected from square, rectangular, semi-circular, oval, circular, trapezoidal and triangular, a gap on the dielectric substrate between the radiator and the ground plane, a radiator attachment pad positioned on the radiator, and a ground plane attach positioned on the ground plane, wherein the antenna is not externally grounded; and
operating the ultra-wideband antenna at radio-frequency communications from 3.1 GHz to 10 GHz.

21. The ultra-wideband omnidirectional antenna method of claim 20 further comprising the step of:
streaming at least one of an audio content and a video content in real-time.

22. The ultra-wideband omnidirectional antenna method of claim 20 further comprising the step of:
processing greater than 100 Mbps of data.

23. The ultra-wideband omnidirectional antenna method of claim 20 further comprising the step of:
processing with the antenna a signal an efficiency greater than 75%.

24. An ultra-wideband omnidirectional antenna kit comprising:
one or more ultra-wideband omnidirectional antenna comprising a dielectric substrate having a substrate length, and a substrate width, a first surface, and a second surface, a radiator positioned on a portion of the first surface of the dielectric substrate having a shape selected from square, rectangular, diamond, semi-circular, circular, oval, trapezoidal, and hexagonal, a ground plane positioned on a portion of the first surface of the dielectric substrate adjacent the radiator, a gap on the dielectric substrate between the radiator and the ground plane, a radiator attachment pad positioned on the radiator, a ground plane attach positioned on the ground plane, wherein the antenna is not externally grounded; and
one or more ground planes, PCBs, connectors, and cables.

25. An ultra-wideband omnidirectional antenna kit comprising:
one or more ultra-wideband omnidirectional antenna comprising a dielectric substrate having a substrate length, and a substrate width, a first surface, and a second surface, a radiator positioned on a portion of the first surface of the dielectric substrate, a ground plane positioned on a portion of the first surface of the dielectric substrate adjacent the radiator having a shape selected from square, rectangular, semi-circular, oval, circular, trapezoidal and triangular, a gap on the dielectric substrate between the radiator and the ground plane, a radiator attachment pad positioned on the radiator, and a ground plane attach positioned on the ground plane, wherein the antenna is not externally grounded; and
one or more ground planes, PCBs, connectors, and cables.
